(19) United States
(12) Patent Application Publication
(10) Pub. No.: US 2017/0236148 A1
(43) Pub. Date: Aug. 17, 2017

(54) Efficient Content Distribution

(71) Applicant: Google Inc., Mountain View, CA (US)

(72) Inventors: Gavin James, Los Angeles, CA (US); Justin Lewis, Marina del Rey, CA (US)

(21) Appl. No.: 15/044,392

(22) Filed: Feb. 16, 2016

(51) Int. Cl. G06Q 30/02; G06N 7/00; G06F 17/30

(52) U.S. Cl. CPC G06Q 30/0246; G06F 17/30867; G06F 17/3053; G06Q 30/0256; G06N 7/005

(57) ABSTRACT

This document generally describes systems, methods, devices, and other techniques for efficiently distributing electronic content in a network. In one example, the techniques include a computer-implemented method. The method can include identifying, by a computing system, a keyword to evaluate with respect to a particular content provider, evaluating historical records of contribution offers for the keyword by a plurality of content providers in order to determine one or more estimated contribution offers, evaluating historical records of user interaction with content to determine estimated levels of user interaction with the content, determining efficiencies of the keywords based on the estimated levels of user interaction and estimated contribution offers, and modifying a distribution campaign based on the determined efficiencies.

### TECHNICAL FIELD

This document generally relates to predictive modeling, and more particularly to computer-based systems, methods, devices and other techniques for using predictive modeling to efficiently distribute content in a computing environment.

### BACKGROUND

As the Internet has grown, content providers have used various techniques to distribute content to end users by placing content in electronic resources ranging from websites to mobile applications. Content distribution networks have developed that allow content providers to specify when and how content associated with a content provider is to be presented in electronic resources that are managed by entities associated with the content distribution network.

### SUMMARY

This document generally describes systems, methods, devices, and other techniques for optimizing content distribution, such as by providing an indication of keywords or other campaign parameters that a content provider could utilize more effectively. In some implementations, a content distributor can use predictive models to determine, for a particular campaign, an amount that a content provider could increase contributions for a given keyword (or other campaign parameter) while maintaining or bettering a return on investment associated with the keyword or the campaign. This amount is referred to as the keyword's potential efficient contribution, and may be expressed as either an absolute amount or as a difference between the absolute amount and the content provider's current contribution for the keyword. As a general matter in content distribution campaigns, as a content provider increases contributions for a keyword, the volume of impressions, clicks, or conversions that result from content associated with the keyword will tend to increase due to more preferable content placement determined by a content ranking procedure. At some point, however, the content provider's return on investment can decrease as the marginal cost of each additional impression, click, or conversion becomes more expensive. In other words, the efficiency of the content provider's contribution may begin to decrease beyond a certain level of contribution.

In some examples, the subject matter described herein includes computer modeling techniques to predict future outcomes of ranking procedures and predict by how much a content provider could efficiently increase contributions for a keyword (e.g., predict how much a content provider could increase contributions without lowering the content provider's return on investment). The keyword can then be presented to the content provider as a suggestion of an aspect of a campaign for which the provider could efficiently increase investment. In some implementations, the keyword is presented by creating a visualization of the keyword, which is presented in a user interface that provides an interactive environment for presenting keyword suggestions to users and for making automatic changes to a campaign to increase efficiency of contributions for one or more keywords. As described below, the user interface can facilitate completion of multiple different individual tasks through user interaction with a single user interface control or element.

Some implementations of the subject matter described herein can include a computing system. The system can include one or more computers that comprise a content server, a contributions prediction model, a content performance model, an efficiency evaluator, and an interface. The content server can serve content to a client device, wherein the content is (i) selected based at least in part on a keyword associated with a query from the client device and (ii) associated with a particular content provider that has placed an offer in a ranking procedure to contribute to a distribution service to have the content provided along with search results that are generated in response to queries that are associated with the keyword. The contributions prediction model can indicate, based on historical offer data, estimated contribution offers for the keyword that are predicted to occur in ranking procedures during a future period of time. The content performance model can indicate based on historical content performance data, estimated levels of user interaction with the content that are predicted to occur during the future period of time. The efficiency evaluator can (i) determine an estimated efficiency of the keyword based on at least one of the estimated contribution offers and at least one of the estimated levels of user interaction and (ii) evaluate the estimated efficiency of the keyword with respect to a threshold efficiency. The interface can provide, in response to an indication that the estimated efficiency of the keyword is determined to satisfy the threshold efficiency, the keyword as a suggested keyword for which the particular content provider could efficiently increase a contribution level during the future period of time.

These and other implementations can optionally include one or more of the following features. The historical offer data can indicate contribution offers placed by a plurality of content providers in previous ranking procedures to have content that is respectively associated with the plurality of content providers provided along with search results generated in response to queries that are associated with the keyword. The estimated contribution offers indicated by the contributions prediction model can be determined based at least on a portion of the offers placed by the plurality of content providers in the previous ranking procedures.

The efficiency evaluator can determine the threshold efficiency based on actual efficiencies of one or more keywords in a content distribution campaign associated with the particular content provider.

The one or more keywords can include multiple keywords, wherein the threshold efficiency comprises an average of the actual efficiencies of the multiple keywords in the content distribution campaign associated with the particular content provider.

The content associated with the particular content provider can be a first piece of content among multiple pieces of content associated with the particular content provider.

The content server can serve different ones of the multiple pieces of content associated with the particular content provider based on the particular content provider having placed a contribution offer to have content provided along with search results generated in response to queries that are associated with the keyword.

The keyword can be included in the query.

The particular content provider can have achieved a first efficiency for the keyword in an actual campaign by placing a contribution offer of a first value for the keyword. The estimated efficiency for the keyword can indicate how efficient the keyword is predicted to be during the future period of time if the particular content provider were to place a contribution offer of a second value for the keyword for the future period of time, the second value being greater than the first value, the estimated efficiency being equal to or greater than the first efficiency for the keyword that the particular content provider has achieved in the actual campaign.

The interface can provide an indication of the second value or a difference between the second value and the first value to present an indication of how much the particular content provider can increase a contribution offer placed on the keyword without reducing at least one of the first efficiency for the keyword or an average efficiency for multiple keywords in the actual campaign.

The historical content performance data can describe at least one of historical content click-through rates, click-through volumes, or impressions. The estimated levels of user interaction with the content that are predicted to occur during the future period of time can include estimated content click-through rates, click-through volumes, or impressions.

The estimated efficiency of the keyword is expressed as a ratio of conversions, clicks, or impressions to a level of contribution that is estimated to occur during the period of time.

Some implementations of the subject matter described herein can include a computer-implemented method. The method can include identifying, by a computing system, a keyword to evaluate with respect to a particular content provider; evaluating, by the computing system, historical records of contribution offers for the keyword by a plurality of content providers in order to determine one or more estimated contribution offers for the keyword that would be required to cause the computing system to select content associated with the particular content provider for presentation in an electronic resource related to the keyword; evaluating, by the computing system, historical records of user interaction with content to determine, for each of the one or more estimated contribution offers, an estimated level of user interaction that would occur with the content associated with the particular content provider if the particular content provider placed the respective estimated offer; determining, for each of the one or more estimated contribution offers and based at least on the estimated levels of user interaction, an efficiency score that indicates an estimated efficiency of the keyword at a contribution level that corresponds to the respective estimated contribution offer; determining whether at least one of the efficiency scores satisfies a threshold efficiency score; and in response to determining that at least one of the efficiency scores satisfies the threshold efficiency score, providing the keyword as a suggestion to the particular content provider.

These and other implementations can optionally include one or more of the following features. The threshold efficiency score can be determined based on one or more scores that respectively indicate actual efficiencies of one or more keywords in a campaign associated with the particular content provider.

Determining the threshold efficiency score can include determining an average of multiple scores that respectively indicate actual efficiencies of multiple keywords in the campaign.

The computing system can be configured, in response to determining that the at least one of the efficiency scores does not satisfy the threshold efficiency score, to not provide the keyword as a suggestion to the particular content provider.

Identifying the keyword can include selecting a keyword for which the particular content provider has not placed a contribution offer on in a campaign.

Determining efficiency scores for each of the one or more estimated offers can include: generating, based on the estimated contribution offers and the estimated levels of user interaction, a model that indicates estimated efficiencies of the keyword as a function of the particular content provider's contribution level for the keyword; and evaluating the model.

The estimated levels of user interaction can include estimated levels of impressions, clicks, or conversions of the content associated with the particular content provider. The efficiency scores can include ratios of the estimated levels of impressions, clicks, or conversions to (i) the estimated contribution offers or (ii) estimated contribution levels that correspond to the estimated offers.

Some implementations of the subject matter described herein can include a computing system that includes one or more processors and one or more computer-readable media. The media can have instructions stored thereon that, when executed by the one or more processors, cause performance of operations. The operations can include: identifying a keyword to evaluate with respect to a particular content provider; evaluating historical records of contribution offers for the keyword by a plurality of content providers in order to determine one or more estimated contribution offers for the keyword that would be required to cause the computing system to select content associated with the particular content provider for presentation in an electronic resource related to the keyword; evaluating historical records of user interaction with content to determine, for each of the one or more estimated contribution offers, an estimated level of user interaction that would occur with the content associated with the particular content provider if the particular content provider placed the respective estimated offer; determining, for each of the one or more estimated contribution offers and based at least on the estimated levels of user interaction, an efficiency score that indicates an estimated efficiency of the keyword at a contribution level that corresponds to the respective estimated contribution offer; determining whether at least one of the efficiency scores satisfies a threshold efficiency score; and in response to determining that at least one of the efficiency scores satisfies the threshold efficiency score, providing the keyword as a suggestion to the particular content provider.

In some implementations, the subject matter described herein may realize, in certain instances, one or more of the following advantages. Generally, by providing indications of campaign parameters (e.g., keywords, host resource criteria, or targeted end-user demographic criteria) for which a content provider could efficiently increase current contribution (e.g., spend) levels, the content provider can more reliably improve the performance of a campaign. As the performance of a campaign improves, content providers and distributors alike may benefit due to networking effects. End users who are presented the content may also benefit by being better matched to content of interest. For example, in the context of computer-based distribution campaigns, content providers are often unaware of how far they can push their campaign budgets efficiently, and exploring potential distribution avenues (e.g., new keywords) in a guess-and-check fashion can be very costly. It can be especially difficult for some smaller or newer content providers to dedicate a portion of their budgets to exploring new keywords, for example, because after much of the budget is spent targeting the most precise keywords, further investment in targeted distribution can become more expensive as the targeting becomes less precise. The metrics (e.g., potential efficient contribution) and suggestions determined according to the techniques described herein can help content providers to more confidently contribute to (e.g., spend on) new keywords or “double down” contributions to keywords in which the content provider is already invested. In turn, by providing the capability to make suggestions based on potential efficient contribution, the content distributor can enhance its own market position due to increased loyalty from content providers that desire to have their content distributed through the distributor's service.

### DESCRIPTION OF DRAWINGS

FIG. 1 depicts three plots of estimated efficiencies of three different keywords in a campaign as a function of a content provider's contributions for the keywords. Each of the plots also shows a threshold efficiency associated with the content provider, a peak estimated efficiency, and a current efficiency for the respective keyword in the campaign.

FIG. 2 shows an example content distribution network, including a computing system that is operable to serve content based on campaign parameters. The computing system is further operable to compute the potential efficient contribution for keywords and other campaign parameters, and to provide campaign suggestions based on the computed potential efficient contribution values.

FIG. 3 depicts a flowchart of an example process for generating suggestions for keyword investments based on evaluation of the potential efficient contribution for the keyword during a future period of time.

FIG. 4 depicts a flowchart of an example process for generating suggestions for investment in campaign parameters based on evaluation of the potential efficient contribution for the campaign parameters for a future period of time.

FIG. 5 depicts a screenshot of an example user interface for managing a content distribution campaign. The user interface allows a user to interact with a keyword evaluator to identify suggested keywords for which a level of contribution may be efficiently increased and to update parameters associated with a campaign so as to realize a projected potential efficient contribution.

FIG. 6 shows a schematic diagram of a computer system that, in some implementations, may be used to carry out the computer-implemented methods and other techniques described herein.

Like references and symbols among the drawings indicate like elements.

### DETAILED DESCRIPTION

This document generally describes systems, methods, devices, and other techniques for optimizing content distribution campaigns based on predictions of how much a content provider could contribute or increase contributions for a campaign parameter (e.g., a keyword, demographic criteria, or host resource criteria) while continuing to maintain or improve the content provider's current return on investment in the campaign. One of the most vexing concerns of content providers engaging in a distribution campaign is how much to invest in various campaign parameters and how to allocate budget within and among campaigns.

One method by which content providers can test the impact of investing in a given campaign parameter is temporarily increasing contributions for the parameter on an experimental basis and then measuring the impact of the increased contribution. For example, a content provider may increase its maximum offer in a keyword ranking procedure (e.g., keyword auction, offering) implemented by the content distribution service for a period of time, or may direct additional contributions toward targeting a particular demographic for a period of time. Using a variety of tools, the content provider may then evaluate one or more metrics of interest to the content provider to determine whether the impact of the increased contributions (e.g., the volume of increased impressions, clicks, or conversions) justified the increased contribution. However, this type of exploratory activity can be a daunting experience for many content providers. For example, a trial in which a content provider increased contributions for ten keywords may come at a significant cost to the content provider if most of the keywords in the trial yield a negative or below-average return on investment.

In some implementations, the techniques described in this document can enable a computing system, such as a system that serves a content distribution network, to predict whether increased investment in a campaign parameter is warranted, and if so, by how much. Such predictions can be presented to content providers to allow them to make more educated choices about where to make contributions in a campaign. As such, content providers may be armed with information that allows them to more confidently and effectively explore campaign changes, while increasing the likelihood that the changes will positively impact the campaign's return on contributions and decreasing the likelihood that the changes will negatively impact the campaign's return on contributions.

For example, in a keyword-based distribution campaign, a given content provider may run a campaign that currently results in a net (e.g., average) dollar-per-conversion ratio of $14/conversion. Within the campaign, the content provider may currently be invested in a keyword (e.g., “blue widgets”) by a maximum contribution of $3.00 per click. The system can evaluate historical data of ranking procedures for the keyword, as well as historical levels of user interaction with content responsive to the keyword, to build a model that indicates, for a given level of contribution (e.g., a given keyword bid), a predicted efficiency of the contribution (e.g., a predicted dollar-per-conversion ratio, although other efficiency metrics may also be used as discussed herein). Based on the model, the system can determine the potential efficient contribution for the keyword. For example, the system may identify from the model that the content provider could increase its maximum offered contribution on the keyword to $5.00 per click to bring the keyword-specific dollar-per-conversion ratio down from $17/conversion to $14/conversion (e.g., down to the campaign's average ratio).

In some implementations, the techniques discussed herein employ computing systems that perform sophisticated data analytics, model creation and evaluation to determine, on the fly, parameters for optimizing a content distribution campaign. As such, these techniques can provide solutions to inherent technical complications relating to the efficient creation and evaluation of predictive models based on vast amounts of data. For example, predicting results of keyword ranking procedures and modeling future keyword efficiencies can involve dynamic analysis of the behaviors of many different entities from content providers to host resource providers to end users who are provided content. Such analysis would be impracticable in the absence of a computing system, especially given the frequent need to deliver results on a near-instantaneous basis.

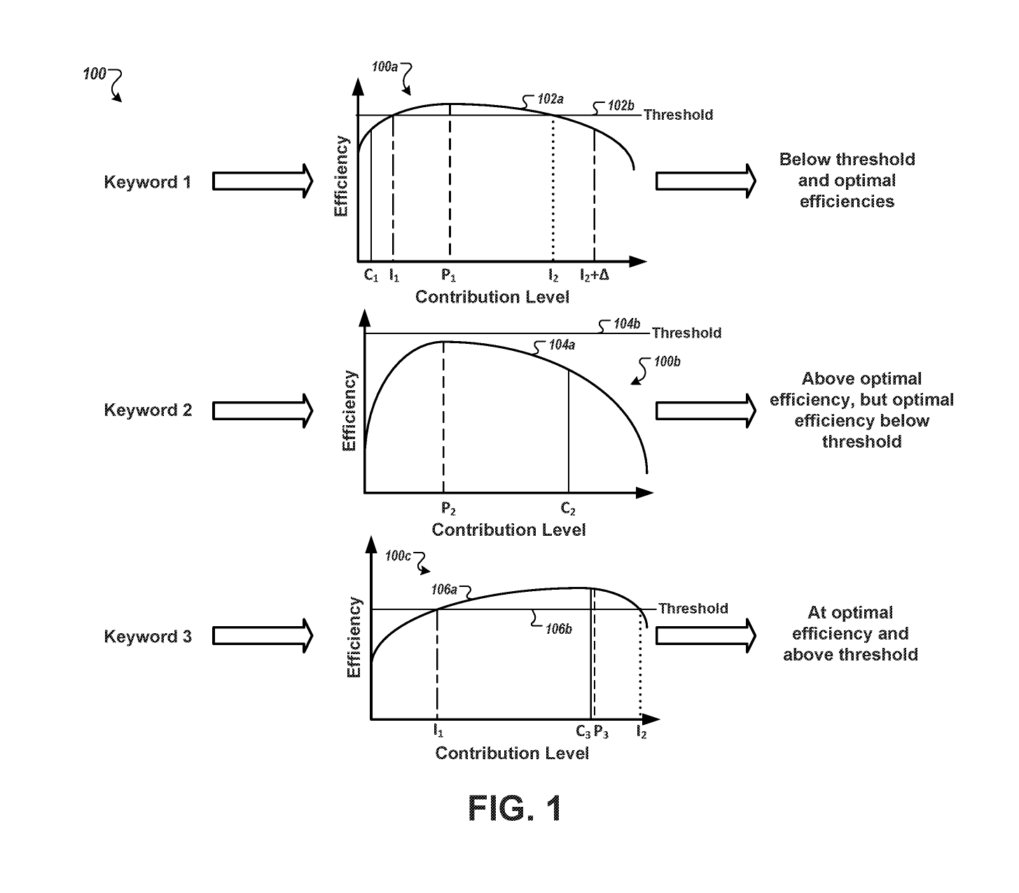

Turning to FIG. 1, a set of plots are shown that conceptually illustrate projected efficiencies of a content provider's contributions for different keywords in a campaign. Various example scenarios are represented by the plots, which can be identified by a computing system in order to determine an appropriate response. By way of example, the scenarios illustrated in FIG. 1 will be described in the context of a content provider's offers for keywords in a computer-based targeted content distribution campaign. However, these scenarios could also be applied to other types of content distribution campaigns, including campaigns where a content distributor accepts content from content providers to be presented on one or more electronic resources associated with the distribution network (e.g., web sites, mobile applications, games, social networks).

In some forms of targeted content distribution, a content provider can create one or more campaigns with a content distribution service to enable distribution of one or more types of content associated with the content provider. The content provider may specify, in each campaign, a set of parameters that indicate what content the content provider desires to be distributed and how to distribute it. For example, the content provider may upload content to the distribution service (e.g., in the form of text, computer code, images, video, or other media files), or may create content directly in an interface provided by the distribution service. The content provider may further specify parameters for how the content should be distributed, such as demographic profiles of users for which the content is targeted, categories of electronic resources that the content is to be displayed on (e.g., search engine results pages, web sites, mobile applications, social networks), topics associated with the electronic resources that the content is desired to be displayed on (e.g., sporting gear, politics, science fiction, history, high-end restaurants, vacations), and more.

In some implementations, the distribution service can be configured to select contents for display in a presentation of search results responsive to user queries. For example, a pizza chain in Minnesota could create a campaign with a distribution service to have its content placed on search result pages in response to user queries related to pizza in Minnesota. To this end, the distribution service may allow content providers, as part of their campaigns, to place offers on keywords for which the content providers would like their content be displayed when a search query is determined to include or otherwise relate to the keyword. Thus, the Minnesota-based pizza chain may place offers on keywords such as “pizza,” “breadsticks,” “Italian food,” “Minnesota,” “Minneapolis,” “St. Paul,” and “Twin Cities.” When a user seeking suggestions for food to eat performs a search with a query that references one or more of these keywords, a search engine may generate and present a user interface that includes lists of both campaign-related search results (e.g., sponsored results selected by a ranking procedure based on offered contributions from a content provider to the distribution service) and non-campaign related search results that are determined to be relevant to the query (e.g., search results identified by crawling and indexing web content). The search engine may provide the query (or an indication of the keyword(s) referenced by the query) to the content distribution service, and the distribution service may select one or more content items to return for presentation on the search results page using the keywords from the query.

In some implementations, the selection of which content items to return is determined by a ranking procedure in which the distribution service accesses data indicating offered contributions (e.g., bids) from the campaigns of content providers that are targeting the relevant keywords. For example, content providers A, B, and C representing three different pizza chains in Minnesota may all compete for slots on a search results page by offering different maximum contributions for a common set of keywords. The distribution service may sell content placement rights to the slots on the search results page based at least on the offered contributions made by the content providers for the keywords that are associated with the particular search. Generally, a content provider that has made the highest offer for a given keyword will be awarded the top-ranked slot for presentation of that content provider's content, and lower-ranked slots may be awarded to content providers that have placed lower offers. In some examples, the slots may be awarded based on a combination of factors, such as the content provider's offers for the keyword and a quality score associated with the content provider's content, landing page, and more.

The distribution service may allow content providers to set parameters in their campaigns that will affect their total contributions for a campaign and/or contributions for individual keywords in the campaign. Such parameters can include the maximum offers made for keywords in the campaign and budgets that impose a cap on the overall contribution in a campaign, or that imposes contribution caps on different portions of the campaign (e.g., contribution caps for individual keywords). Generally, keyword offers indicate how much a content provider is willing to contribute to (e.g., pay) the distribution service to have their content placed in search result pages or other electronic resources (e.g., websites, documents, mobile applications) related to the content provider's targeted keywords. Two common types of keyword offers include cost-per-click (CPC) offers and cost-per-thousand impressions (CPM) offers. With CPC offers, the content provider indicates a maximum amount that the content provider is willing to contribute to the distribution service each time a user selects (“clicks”) the content provider's content when it has been presented on a search results page or on other electronic resources affiliated with the distribution service (e.g., websites, mobile applications). With CPM offers, the content provider indicates a maximum amount that the content provider is willing to contribute to the distribution service for every 1,000 impressions of the content provider's content. An impression is generally a single occurrence of the content provider's content being presented to a user, such as each time content is selected for presentation on a search results page. In some implementations, the content provider may assign, for each targeted keyword in a campaign, a respective maximum offer and a contribution cap for the keyword. The distribution service may continue to serve the content provider's content based on the maximum offered contribution for the keyword (and based on additional factors in some examples) until the total cost to the content provider for serving content for that keyword reaches a contribution cap associated with the keyword or the campaign.

In some implementations, a content provider may be concerned with the efficiency of a campaign, and with the efficiency of the content provider's expenses with respect to particular portions of a campaign. As used herein, efficiency relates to the content provider's return on investment in a campaign or in a portion of a campaign (e.g., return on investment in a particular keyword). Depending on the content provider's preferences and the particular context of a given campaign, efficiency may be measured with different metrics to indicate the return on investment. Generally, however, the efficiency of a campaign or portion of a campaign can be described in terms of a ratio of a level of user interaction with particular content associated with a campaign to a level of the content provider's contributions for the campaign or portion of the campaign that is required to achieve the level of user interaction with the content.

In some implementations, the level of user interaction may refer to a volume of impressions of the content provider's content, a volume of clicks of the content provider's content, or a volume of conversions resulting from servings of the content provider's content. A conversion generally refers to a measurable action that a user takes with respect to the content provider as a result of presenting the content provider's content (e.g., content). For example, a conversion may be a placed order for a content provider's product or service by a user who clicked on content and was directed to the content provider's website where the order could be made. Depending on the content provider's business model, conversions may take different forms. For example, a mobile application developer may count conversions as downloads of the developer's software by a user who was directed to the developer's website via a link presented on a search results page as part of a campaign.

In some implementations, the “contribution” component of the efficiency metrics discussed herein may refer to a total cost to the content provider charged by the distribution network to serve the content provider's content (e.g., a content provider's actual investment during a period of time in a keyword) in association with a given keyword over a period of time. In some implementations, the “contribution” component of the efficiency metrics discussed herein may refer to campaign parameters that indirectly affect the content provider's total contributions for a keyword or other aspect of a campaign over a period of time, such as the content provider's budget or maximum offered contribution for a keyword. For example, the efficiency of a given keyword in a campaign may be expressed as a number of conversions per dollar, a number of clicks per dollar, or a number of impressions per dollar. Higher efficiencies are generally preferred by content providers, as they indicate that the content provider is receiving greater value for each unit of contribution made (e.g., dollars spent). In some implementations, efficiencies can also be expressed inversely from the preceding examples, such as the cost per click (CPC), cost per 1,000 impressions (CPC), or cost per conversion. In these examples, content providers generally strive to achieve lower ratios, which indicate higher efficiencies. In some implementations, efficiency may be expressed in terms of an effective cost per 1,000 impressions (eCPM), which indicates a content provider's actual cost to achieve 1,000 impressions of the content provider's content.

In some implementations, content providers can associate multiple pieces of content with a keyword in a campaign. For example, the content provider may create three different content items from which the distribution service may select to present in a search results page related to pizza. In this case, an efficiency score for the keyword ‘pizza’ may indicate the relative levels of contribution and user interaction based on all three of the content items that are associated with the keyword, or based on a combination of one or more of the content items.

Referring again to FIG. 1, three plots are depicted of estimated efficiencies of three different keywords in a campaign during a future period of time as a function of the content provider's contributions for each of the keywords. In some implementations, the estimated efficiencies can be determined based on historical data about levels of contribution and user interactions with the keyword, including by using computer models to predict efficiencies based on the historical data and accounting for the specific parameters of a given content provider's campaign. The period of time for which the estimated efficiencies are derived can be automatically selected by a computing system based on pre-defined rules, or can be manually specified by an agent of a content provider and inputted to the computing system. For example, the content provider may provide input to a computing system that instructs the system to determine estimated efficiencies over a number of coming days, weeks, or months as desired.

Each of the plots 100a-c shown in FIG. 1 illustrates a different example scenario with respect to keyword efficiencies. First, the top plot 100a shows the estimated efficiencies 102a of a first keyword (Keyword 1) as a function of a content provider's level of contributions for the first keyword. The plot 100a also shows a threshold efficiency 102b, a current level of contribution for Keyword 1 in the campaign (indicated by the vertical line labeled C₁), an optimal level of contribution that is projected to result in peak efficiency (indicated by the vertical line labeled P₁), a first threshold level of contribution at which the estimated efficiency 102a intersects the threshold efficiency 102b (indicated by the vertical line labeled I₁), and a second threshold level of contribution at which the estimated efficiency 102a intersects the threshold efficiency 102b (indicated by the vertical line labeled I₂). Plot 100a indicates that the content provider's current level of contribution C₁ would result in a sub-optimal estimated efficiency. In other words, a computing system may analyze the data represented by the plot 100a to determine that the content provider could increase contributions for Keyword 1 by a certain amount without decreasing the average efficiency of keywords in the campaign (e.g., represented by the threshold efficiency 102b). For example, if the content provider increased contributions for Keyword 1 from the current level C₁ to the peak level P₁, optimal efficiency would be achieved. Accordingly, the computing system may suggest to the content provider that the level of contributions for the keyword be increased from C₁ to P₁.

In some implementations, the threshold 102b may be determined based on actual efficiencies of one or more keywords achieved by the content provider in a campaign. For example, the computing system may take as the threshold efficiency the average current efficiencies of all or a subset of keywords that a content provider has previously placed offers on in a campaign. Thus, if a content provider has previously achieved efficiencies of 0.2, 0.1, 0.15, 0.05, and 0.25 conversions per dollar for five keywords in a campaign, respectively, the threshold efficiency may be set as 0.15 conversions per dollar (mean and/or median efficiency). In some implementations, the threshold may be set as the actual efficiency associated with only the keyword under analysis (here, Keyword 1). As plot 100a shows, the efficiency that is predicted to result at the content provider's current contribution level C₁ is below the threshold efficiency 102b. If the threshold efficiency 102b represents an average campaign efficiency across multiple keywords, for example, then plot 100a shows that the estimated efficiency at the current contribution level C₁ falls below the campaign's average efficiency, and that the content provider could increase its contributions for Keyword 1 from C₁ to I₁ to raise the efficiency associated with Keyword 1 to the campaign's average efficiency. Moreover, in this example, it would be possible for the content provider to increase contributions up to I₂ without falling below the campaign's average efficiency. The content provider could also contribute a small amount above I₂ (i.e., I₂+Δ) without falling below the projected efficiency of Keyword 1 given the current contribution level C₁. In some implementations, the content distribution service can present data to the content provider that indicates the content provider could efficiently increase contributions to I₁, P₁, I₂, or I₂+Δ while maintaining or bettering the campaign's average efficiency, or while maintaining or bettering the projected efficiency of the keyword given the current contribution level C₁.

The second plot 100b shown in FIG. 1 illustrates the projected efficiency 104a of a second keyword (Keyword 2) in the content provider's campaign during a future period of time as a function of the content provider's contributions for the second keyword. In this example, the current contribution level C₂ is above the peak contribution level P₂ at which the efficiency of Keyword 2 if predicted to be greatest. The content provider, of course, may have reasons to contribute above the peak efficiency level P₂, because doing so will generally result in greater levels of user interaction (e.g., impressions, clicks, or conversions) with the content provider's content, even though the additional user interactions come at a higher cost to the content provider. Here, however, the efficiency curve 104a never exceeds the threshold efficiency 104b. As such, the distribution service may suggest that the content provider decrease contributions toward Keyword 2 in favor of contributions toward other keywords that may realize higher efficiencies for the content provider. In some implementations, the distribution service may present data to the content provider that indicates the current contribution level C₂ could be decreased to P₂ to achieve the most efficient contribution for Keyword 2.

The third plot 100c shown in FIG. 1 illustrates the projected efficiency 106a of a third keyword (Keyword 3) in the content provider's campaign during a future period of time as a function of the content provider's contributions for the third keyword. In this example, the content provider's current level of contribution C₃ is essentially equal to the projected peak level of contribution P₃ at which the content provider could achieve the greatest efficiency for Keyword 3. As such, the distribution service may recommend to the content provider that the current level of contribution C₃ be maintained during the future period of time (e.g., maintain the current maximum offer and budget constraints) in order to achieve optimal efficiency.

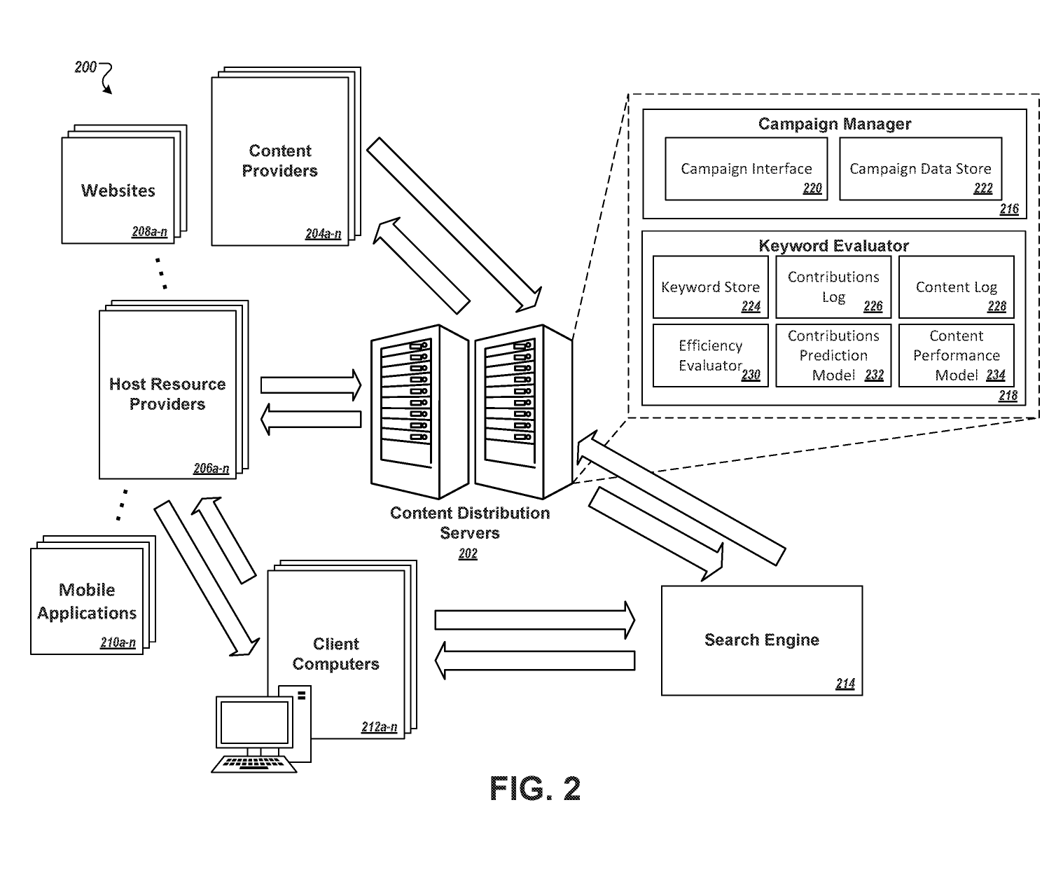

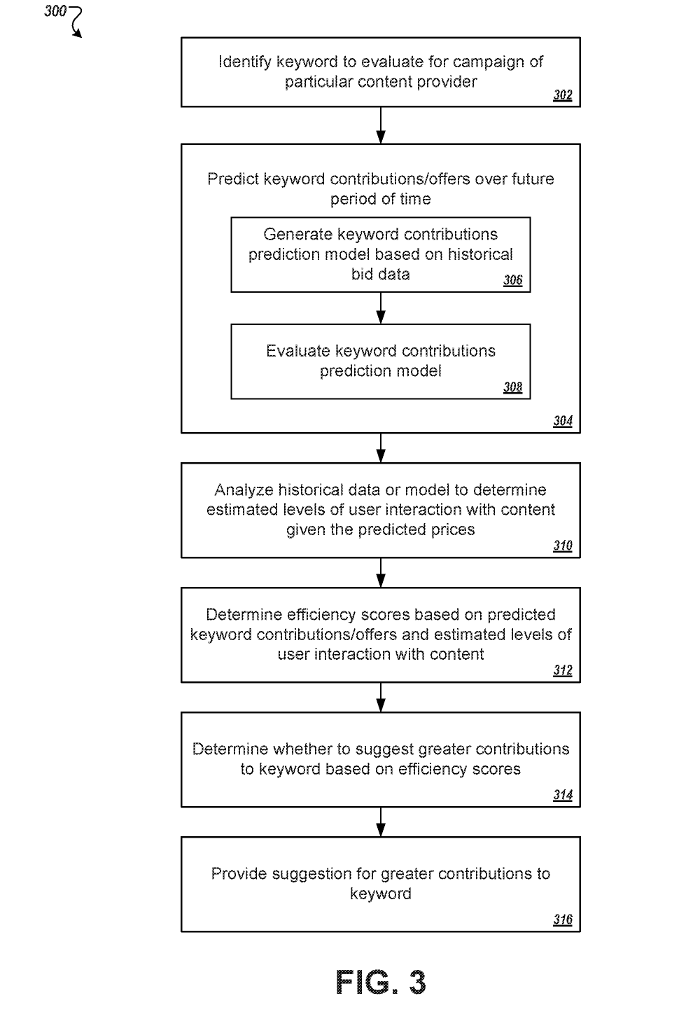

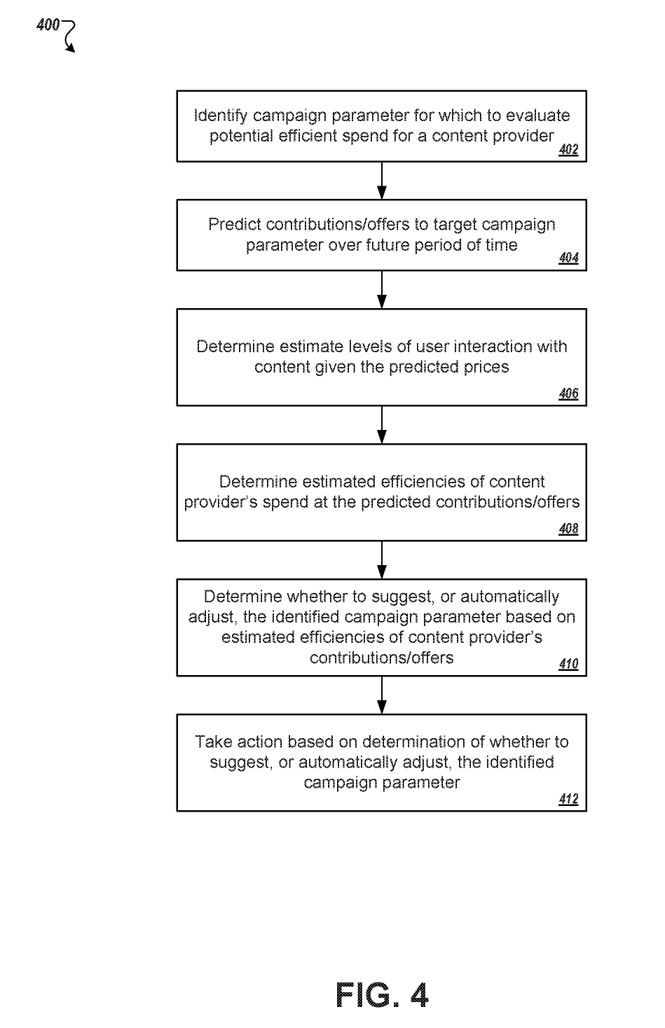

Turning to FIG. 2, an example computing system 200 is shown for a content distribution network. The system 200 is generally capable of serving content based on criteria indicated in campaigns associated with different content providers 204a-n. The system 200 is further capable of computing the potential efficient contribution for keywords and/or other campaign parameters, and can provide suggestions for managing a campaign based on the computed potential efficient contribution values. In some implementations, the system 200 can include a combination of hardware and software that is configured to perform the computer-implemented methods described herein, such as processes 300 (FIG. 3) and 400 (FIG. 4).

The system 200 conceptually represents a content distribution network that includes one or more content distribution servers 202, a search engine 214, one or more content providers 204a-n, one or more host resource providers 206a-n, one or more websites 208a-n managed by the host resource providers 206a-n, one or more mobile applications 210a-n managed by the host resource providers 206a-n, and one or more client computers 212a-n. Generally, the distribution servers 202 run a content distribution service that involves interactions among various stakeholders in the distribution network, including content providers 204a-n, host resource providers 206a-n, and end users who are provided content at client computers 212a-n. In some implementations, the distribution service enables content providers 204a-n to create campaigns for distributing content associated with the content providers 204a-n.

In some implementations, the distribution servers 202 allow content providers 204a-n to place offers on one or more campaign parameters that indicate how the content providers 204a-n desire to target their content to end users. For example, the content providers 204a-n may offer maximum contributions for keywords. When the keyword appears in a search query entered at the search engine 214, the content distribution servers 202 can select, using a ranking procedure, content to present on a search results page responsive to the query based at least in part on the offers submitted for the keyword by different content providers 204a-n. In some implementations, the distribution servers 202 can select content to present on electronic resources managed by the host resource providers 206a-n, such as websites 208a-n or mobile applications 210a-n, based on keywords for which the content providers 204a-n have made contributions (or placed a maximum contribution offer that was accepted by a ranking procedure and used to charge the content provider for placing the provider's content in an electronic resource associated with a given keyword). For example, if a website is determined to relate to a topic associated with a keyword that a content provider has made a sufficiently high offer for, the content distribution servers 202 can then provide content associated with the content provider for display on the website.

In some implementations, the content distribution servers 202 can include a campaign manager 216. The campaign manager 216 and its components may each be implemented as a set of computing hardware that is specially configured to execute machine-readable instructions that cause the set of computing hardware to perform specific functionality as described herein. The campaign manager 216 enables content providers 204a-n to create campaigns for distributing content across the network 200. The campaign manager 216 can include a campaign interface 220 and a data store 222 for maintaining information about campaigns. In some implementations, the campaign interface 220 provides a web-based portal that allows content providers 204a-n to create, terminate, suspend, and modify campaigns. For example, the interface 220 may provide one or more user interfaces that include forms in which a content provider can enter campaign parameters such as keywords that the content provider would like to place a contribution offer, identification of one or more pieces of content that are to be distributed in the campaign, associations of one or more pieces of content with each keyword that the content provider offers, maximum offers for keywords, descriptions of electronic resources that the content provider would like to target for placement of the provider's content, and descriptions of end users that the content provider would like to target with the campaign (e.g., demographic profiles). The content provider may also specify a budget for the campaign and how much contribution should be allocated to individual keywords or groups of keywords in the campaign. The campaign parameters can be stored in the data store 222.

The content distribution servers 202 can also include a keyword evaluator 218. The keyword evaluator 218 and its components may each be implemented as a set of computing hardware that is specially configured to execute machine-readable instructions that cause the set of computing hardware to perform specific functionality as described herein. In some implementations, the keyword evaluator 218 is realized in a computing environment that enables a real-time interactive experience. For example, the keyword evaluator 218 can accept input from a content provider and generate or update a user interface to present a set of keyword information that is responsive to the accepted input.

The keyword evaluator 218 includes a set of components 224-234 that are collectively capable of predicting the performance of a given keyword over a future period of time and determining the potential efficient contribution for the keyword in the context of a particular campaign. Based on a result from the keyword evaluator 218, the campaign interface 220 can then present information to a content provider about the efficiency of a keyword in a campaign. For example, the campaign interface 220 may suggest existing keywords that the content provider has placed offers on in a campaign for which the content provider could efficiently increase contributions. The keyword evaluator 218 may also or alternatively return indications of new keywords that the content provider is not currently invested in (e.g., keywords for which the content provider does not have outstanding offers) but for which the content provider could likely incorporate into the campaign efficiently.

The keyword store 224 includes a list of keywords that are to be evaluated. In some implementations, the keyword store 224 can retrieve keywords from the data store 222 so as to access all or some of the keywords in a particular campaign. For example, the keyword evaluator 218 may automatically and periodically generate efficiency reports for a content provider about which keywords in a campaign are efficient (e.g., above the campaign's average efficiency) and which keywords in the campaign are less efficient (e.g., below the campaign's average efficiency). The keyword evaluator 218 may also identify any keywords in a campaign for which the content provider could efficiently increase contributions, regardless of whether the projected efficiencies of those keywords at current contribution levels are above or below the campaign's average efficiency. In some implementations, the keyword store 224 can include data that maps relationships among different keywords. Based on the data about related keywords, the keyword store 224 can identify related keywords that are not in a content provider's current campaign. The related keywords can then be evaluated to determine whether their efficiencies would be sufficiently high to suggest to the content provider for possible inclusion in the campaign. In some implementations, related keywords can be identified by identifying keywords that other content providers have made contribution offers for in other campaigns, where the other content providers, the other campaigns, or both are determined to be similar to the content provider or campaign for which a suggestion is being made. In some implementations, related keywords can be identified by determining relationships among keywords in query logs.

The contributions log 226 stores historical data about actual keyword contributions made by content providers 204a-n and/or historical data about keyword contribution offers made by content providers 204a-n as input to ranking procedures that are performed by a distribution service to select and place content in electronic resources for distribution. As used herein, the term ‘log’ may refer to machine-readable media that stores digital data about information. The historical data may include, for example, the maximum contribution offers made by content providers 204a-n that were submitted in previous ranking procedures (e.g., auctions) for the keywords and actual contributions made (e.g., prices paid) by content providers 204a-n in the previous offerings. In some implementations, the maximum offers made by content providers 204a-n may be greater than the actual contributions made. For example, the maximum offers of each content provider in a keyword offering may be weighted based on factors such as the quality of the content that the provider desires to be distributed. Further, the “winner” in some offerings may be charged not the winner's offer (or weighted offer), but instead may be charged the offer (or weighted offer) of the offering's runner-up (e.g., a second-price ranking procedure).

In some implementations, the historical data may include timestamps that indicate the relevant date/time of the offers contained therein. The timestamped data may be used to make temporal-based adjustments to the estimated offers for a keyword depending on the particular period of time for which the offers are to be predicted. For example, the contribution cost (e.g., prices) of some keywords may fluctuate seasonally (e.g., “Christmas,” “Halloween,” “golf,” “pools”). Contribution costs of some keywords may even vary on a daily basis. For example, “clubs” and “pizza” may be more popular—and therefore expensive—on Thursdays-Saturdays, but less popular on other days of the week. Accordingly, the keyword evaluator 218 may in some implementations generate the contributions prediction model 232 based on historical data from the contributions log 226 that matches the targeted period of time for which the predicted offers are desired.

The contributions prediction model 232 is capable of determining one or more estimated contributions that are predicted to be offered or made for a keyword during a future period of time. In some implementations, the contributions prediction model 232 indicates, based on the historical offer data in contributions log 226, estimates of the winning offers (e.g., maximum contribution offers made by content providers that achieved the winning offers, actual contributions made by the winning content providers, or both) for keyword ranking procedures (e.g., offerings) that are predicted to occur during the specified future period of time. In some implementations, predicting the winning offers can involve running computer simulations of ranking procedures for a keyword that are projected to occur during the future period of time. The predicted (estimated) winning offers may be based on the predicted behaviors of many content providers in making offers for the keyword as part of a given ranking procedure. In some implementations, the predicted winning offers can be determined using time-series prediction techniques. In some implementations, the contributions prediction model 232 may output information that indicates, for each ranked slot that is capable of receiving content on a search results page, the predicted offer (e.g., maximum offer or actual contribution made) that would be required for content associated with a content provider's campaign to be selected for presentation in the respective slot. For example, contributions prediction model 232 may indicate that the top slot on a search results page would require a CPC offer of $3.00, and that the second and third slots on the page would require CPC offers of $2.50 and $2.00, respectively.

The content log 228 stores information about historical levels of user interaction with content that has been served to end users at client computers 212a-n through the content distribution service. In some implementations, the content log 228 can include entries that indicate, for each of a plurality of different pieces of content (e.g., advertisements), one or more metrics of user interaction with the respective piece of content over a period of time. The content log 228 can also store data indicating context for user interactions with content, such as information about users who interacted with the content, timestamps that indicate when the interactions occurred, and indications of the electronic resources where the interactions occurred (e.g., identity of the mobile application, website, or search results page where the content was displayed when the interactions occurred).

The content log 228 can also include information about the quality of the presentation of the content when the interactions occurred. In some implementations, the quality of the presentation of content can correspond to how prominently the content was featured on a given electronic resource. For example, a higher presentation quality score may be assigned to content that is displayed in the top slot of a search results page, whereas lower presentation quality scores may be assigned to content displayed beneath the top slot of the search results page. The presentation quality score may be relevant to predicting future levels of user interaction with content based on the historical data because content that is more prominently displayed on a resource can generally be expected to receive more clicks, for example. In some implementations, the content log 228 may store one or a combination of multiple different measures of user interaction with content, such as a total number of impressions of particular content over a period of time, a total number of clicks of particular content over a period of time, a total number of conversions stemming from particular content over a period of time, and a click-through rate of particular content over a period of time.

The content performance model 234 is generally capable of determining one or more estimated levels of user interaction with content served to end users as part of a distribution campaign in association with one or more keywords. In some implementations, the content performance model 234 is a predictive model that interpolates and/or extrapolates levels of user interaction with content based on the historical records of user interaction with content indicated by the content log 228. The content performance model 234 may accept one or more campaign parameters as input to the model, and may output the estimated levels of user interaction based on the input parameters. The input parameters may also include factors such as a presentation quality score and, depending on the particular metric of user interaction that is to be determined, other metrics of user interaction that are usable to determine the target metric. For example, the model 234 may determine a total number of impressions that are likely to be received for content associated with a particular keyword over a period of time given a campaign's maximum offer for the keyword and content quality score. In another example, the model 234 may determine an estimated click-through rate for content based at least on its presentation quality score (e.g., an indication of the prominence of the content's presentation in a search results page or other electronic resource). In some implementations, the output of the model 234 may be estimations of volume of impressions (e.g., total number of impressions over a period of time), volume of clicks, volume of conversions, click-through rate, or conversion rate for content associated with a keyword in a campaign. In some implementations, such estimated levels of user interaction with content served by the distribution service can be determined based on predicted network traffic conditions, query trends, and comparison of such information to levels of user interaction achieved given historical traffic conditions and query trends. Generally, techniques for predicting levels of user interaction can include identifying one or more trends from historical data and applying a linear or non-linear regression model based on the trend. Cyclical functions and/or polynomial functions can be applied to the model inputs (e.g., contribution offers for similar keywords, sector, seasonality (both large scale such as time of year and small scale such as time of day or day of week), content quality, and relevance.

Next, the efficiency evaluator 230 is capable of determining estimated efficiencies of a content provider's contributions to a keyword in a campaign based on estimated contribution data and estimated levels of user interaction with content during a future period of time. In some implementations, the efficiency evaluator 230 can generate, based on the contributions prediction model 232 and the content performance model 234, an efficiency model that outputs estimated efficiency scores for a keyword. The scores can indicate estimated efficiencies for the keyword that are predicted to result during a future period of time as a function of the content provider's level of contributions for the keyword. In some implementations, the estimated efficiency scores for a keyword may be represented in plots like those that are shown conceptually in FIG. 1. For example, to determine the estimated efficiency of a keyword, the efficiency evaluator 230 can identify an estimated “winning” offer from the contributions prediction model 232, an estimated level of user interaction that corresponds to the “winning” offer from the content performance model 234, and can calculate a ratio of these values to determine the estimated efficiency.

For purpose of calculating estimated efficiencies, estimated offer values may in some implementations be converted to total keyword contribution values based on the offer values and estimated levels of user interaction. For example, if the models predict that a $6.00 CPM offer will yield 12,000 impressions over a future period of time, then the total predicted contribution would be $72.00 for the future period of time on the keyword. The efficiency can then be expressed, for example, as 166.67 impressions per dollar. In some implementations, the efficiency evaluator 230 may compute efficiencies in other forms as well, such as conversions per dollar, clicks per dollar, or earnings per dollar.

In some implementations, the efficiency evaluator 230 can evaluate the contributions prediction model 232 and the content performance model 234 to determine a potential efficient contribution for a keyword. The potential efficient contribution generally describes (i) an absolute contribution value that a content provider could contribute toward a keyword in a campaign while maintaining or improving a threshold efficiency associated with the campaign, or (ii) an amount of contribution that a content provider could increase from a current level of contribution for a keyword in a campaign while maintaining or improving the threshold efficiency (i.e., a difference between the absolute potential contribution value and the content provider's current contribution). In some implementations, the absolute potential efficient contribution is the level of contribution at which the estimated efficiency curve intersects the threshold efficiency, such ash or I₂ in plot 100a (FIG. 1). In some implementations, the efficiency evaluator 230 may also determine the peak contribution level, which is the contribution level at which a keyword is most efficient (e.g., P₁ in plot 100a of FIG. 1). In some instances, such as where the threshold efficiency is set to the estimated efficiency for the current contribution level (e.g., C₁ in plot 100a of FIG. 1), the absolute potential efficient contribution can equal the contribution level at which the estimated efficiency of the keyword next falls below the estimated efficiency of the current contribution level for the keyword (e.g., I₂+Δ in plot 100a of FIG. 1).

In some implementations, the efficiency evaluator 230 can determine the threshold efficiency based on actual performance characteristics of a campaign. For example, the threshold efficiency may be determined as the average efficiency among all or a subset of keywords that a content provider has offer on in a campaign. As such, potential efficient contribution can be determined relative to a given campaign's current performance. In some implementations, the threshold may be determined based on actual efficiencies achieved by campaigns of one or more other content providers. For example, the content distribution service may track efficiencies of campaigns for similar content providers and may use an average of these efficiencies as a target threshold efficiency for another content provider's campaign. In some implementations, the threshold efficiency may be manually input by the content provider, thereby allowing the content provider to test the effect of applying different threshold values or allowing the content provider to apply a target threshold value that the content provider aspires to achieve.

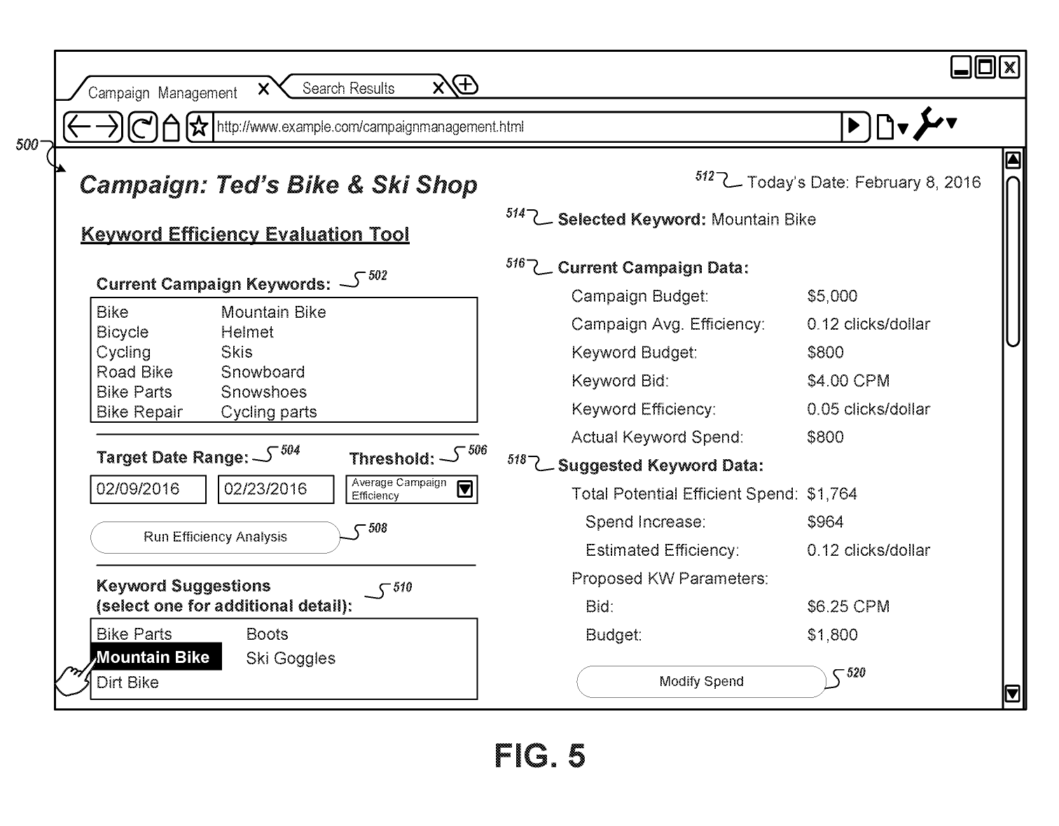

In some implementations, once the potential efficient contribution for a keyword is determined, the keyword evaluator 218 can provide the value for the potential efficient contribution to the campaign interface 220 for presentation to the content provider associated with a campaign. The potential efficient contribution may be presented as a suggestion to the content provider about where additional investment in the campaign may be worthwhile, both for increasing contribution in an existing campaign keyword or for contributing to a newly identified keyword. In some implementations, the keyword evaluator 218 may determine the potential efficient contribution for multiple keywords in a campaign, and based on the potential efficient contribution values for each of the keywords, may present a list of identified keywords to the content provider for which increased contributions could be implemented without falling below a threshold efficiency (e.g., without falling below the campaign's average efficiency). In some implementations, the list of keywords presented as suggestions may be filtered to include only those identified keywords that have current efficiencies below the campaign's average efficiency. An example user interface for providing keyword suggestions and automatically modifying contribution in a campaign to efficient levels is depicted in FIG. 5.

In some implementations, a keyword may not have a valid potential efficient contribution value. For example, if the keyword evaluator 218 determines that increasing contributions for a keyword will result in decreasing efficiency, then that keyword may not be identified as a suggestion for increased contribution. In some implementations, the potential efficient contribution may be presented to an operator of the content distribution service, for example, as a lead that can in turn be presented to the content provider as a growth opportunity for the campaign. In some implementations, the campaign manager 216 may make automatic adjustments to a campaign based on the potential efficient contribution for a keyword. The content provider managing a campaign may opt-in or opt-out of allowing the distribution service to apply automatic adjustments. For example, in response to the keyword evaluator 218 conveying to the campaign manager 216 a potential efficient contribution value for a keyword, the campaign manager 216 may automatically adjust campaign parameters to achieve the potential efficient contribution. In some implementations, the campaign adjustments may include increasing a budget or contribution cap associated with the keyword, increasing a maximum offer for the keyword, or both.

In some implementations, the keyword evaluator 218 may monitor the performance of a campaign in real-time and take appropriate action during the course of the campaign to alert the content provider of opportunities to increase efficiency, make automatic campaign adjustments to increase efficiency, or both. For example, the campaign interface 220 may provide one or more controls in a user interface that allows the content provider to opt-in or opt-out of real-time campaign monitoring, alerts, automatic adjustments, or a combination of these. With real-time monitoring, the keyword evaluator 218 may periodically (e.g., hourly, daily, weekly) evaluate the efficiency of existing keywords in the campaign and seek new keywords that the content provider could be invested in efficiently over a coming period of time. If an opportunity to make an efficient investment is identified, the campaign manager 216 (e.g., the campaign interface 220) may present such opportunities in a campaign management dashboard or user interface for the content provider, and may also push an alert to a content provider through one or more preferred channels. For example, the campaign interface 220 may be configured to provide the content provider with e-mails or short-message service (SMS) text message alerts at a mobile device immediately when a new efficient keyword opportunity is identified. In some implementations, the alerts may be generated by a campaign management application (e.g., a mobile application) installed on the content provider's device. The alert can cause the mobile device to generate a visual indication of the identified keyword opportunity, an audible indication of the opportunity, and to provide haptic feedback to the user when the alert is received. In some implementations, the user (e.g., an agent of the content provider) can, upon receiving the alert, select a control on the mobile device to review additional detail about the opportunity and can confirm whether to modify the campaign in the suggested manner. If the user selects to modify the campaign, the changes can be implemented so that content is distributed according to the modified campaign parameters.

Referring now to FIG. 3, a flowchart is shown of an example process 300 for determining the potential efficient contribution of a keyword in a content distribution campaign, and for providing a suggestion to a content provider based on the potential efficient contribution. In some implementations, the process 300 may be performed by a computer-implemented device or system like those described herein, such as the content distribution system 200 of FIG. 2. In some implementations, the process 300 can include operations that are discussed elsewhere in this document including operations like those discussed with respect to FIGS. 1, 2, 4, and 5.

At stage 302, the process 300 identifies a keyword for which to evaluate its potential efficient contribution in a campaign of a content provider. In some implementations, the keyword is selected from among one or more keywords that the content provider has previously offer on in a campaign. In some implementations, the keyword can be selected from a list of keywords that are not presently being used in a campaign. For example, a content distribution service may identify one or more electronic resources associated with the campaign and/or the content provider (e.g., type of products or services being offered, location information, targeted campaign demographics), and may use those resources to determine candidate keywords that the content provider could consider incorporating into the campaign. However, before the distribution service recommends a candidate keyword, the process 300 may be performed with respect to the keyword to determine its potential efficient contribution. The distribution service may then determine whether to present the candidate keyword to the content provider based on the keyword's potential efficient contribution. If, for example, the process 300 determines that the content provider cannot efficiently invest in a new keyword, then the process 300 may not suggest the keyword to the content provider. But if the process 300 determines that a new keyword can be efficiently invested in, a recommendation for the keyword may be presented to the content provider. In some implementations, the recommendation or suggestion presented to the content provider may also include an indication of how much the content provider could efficiently contribute to the keyword, such as a maximum contribution amount before the projected efficiency of the keyword falls below a threshold efficiency (e.g., the campaign's average efficiency).

At stage 304, the process 300 predicts keyword contribution costs for a future period of time. For example, a content distribution service may implement a ranking procedure for content providers to have their content presented in association with different keywords. In some implementations, the ranking procedure can involve receiving the contribution offers from a plurality of content providers, and selecting content corresponding to one or more of the content providers to present in electronic resources (e.g., web pages) that have allocated slots for distributed content. The ranking procedure may select content based at least in part on the contribution offers. For example, the content providers that made the three highest contribution offers may have their content presented on a search results page, and the distribution service may charge the selected content providers based on their contribution offers.

The future contribution costs that the process 300 estimates for the keywords can be determined, in some implementations, using a predictive model that is derived from historical pricing data for keywords. At sub-stage 306, the process 300 can include generating a keyword contributions prediction model (e.g., contributions prediction model 232) using historical offer data (e.g., data contained in contributions log 226). The contributions prediction model may indicate, for example, the minimum value for a maximum offer that would be required for a content provider to be ranked at a given slot in a ranking procedure. For example, a ranking procedure in the form of a keyword offering may have multiple “winners” when multiple slots are available for campaign content to appear on a search results page or another resource that is capable of presenting distributed content associated with the content distribution service. The multiple winners may be ranked based at least on the maximum offers for a given keyword offered by different content providers. The top-ranked winner may have content presented in the most premium location (slot) on a webpage, and lower-ranked winners may have their content presented in locations with progressively descending quality. The different locations available for campaign content in an electronic resource may be referred to as “slots.” Accordingly, in some implementations, the contributions prediction model may indicate offers that are estimated to be required during the future period of time for a content provider to be awarded a given slot. The contributions prediction model may determine the offers that would be required in a future keyword offering to have content selected for display in any one, some, or all of the available slots in an electronic resource. In some implementations, the contributions prediction model can be created using time-series prediction techniques. At sub-stage 308, the contributions prediction model is evaluated to determine the estimated offers for at least one offering or other ranking procedure during the future period of time.

At stage 310, the process 300 determines estimated levels of user interaction with content that are likely to occur during the future period of time given the different levels of contribution (e.g., actual contributions made and/or maximum contribution offers) that were predicted at stage 304. For example, the process 300 may determine the level of user interaction that would result from a first-ranked offer, a second-ranked offer, a third-ranked offer, and so on. The estimated levels of user interaction may indicate, for example, a number of impressions that are predicted to occur over a future period of time for content associated with a keyword in a particular campaign, a number of times that users are predicted to click on (select) content associated with the keyword, or a number of conversions that are predicted to result from the content at a given contribution level or contributions-offer level. For example, the estimated levels of user interaction may indicate that, given a CPC offer of $5.00, a content provider could expect 12,000 impressions and 200 clicks over a certain period of time, but that given a CPC offer of $4.50, a content provider could expect 8,000 impressions and 90 clicks over that period. In some implementations, the estimated levels of user interaction can be determined by evaluating a model (e.g., content performance model 234) that reflects historical levels of user interaction with the content (e.g., the historical data contained in content log 228). For example, a computing system for a content distribution network may analyze the total volume of content displayed in response to queries related to a particular keyword, and may determine the estimated level of user interaction that would be likely to occur with a portion of the content belonging to a particular content provider if the content provider placed various offers for the keyword.

At stage 312, the process 300 determines estimated efficiencies for a keyword in the context of a particular campaign based on the predicted keyword and estimated levels of user interaction. In some implementations, an estimated efficiency of a keyword can be expressed as a ratio of the estimated level of user interaction with content at a given contribution cost to that that contribution cost. For example, if the process 300 estimates that a content provider would realize 12,000 impressions with a $200 total investment on a keyword, then the efficiency is 60 impressions/dollar. In some implementations, efficiency may be measured in other ways, such as a number of clicks per dollar or a number of conversion per dollar. Generally, the efficiency of a keyword indicates a measure of the content provider's return on investment in the keyword. In some implementations, the process 300 can build a model that indicates the projected efficiency of a keyword as a function of contribution (e.g., total projected actual contribution or offer values).

At stage 314, the process 300 computes the potential efficient contribution for a keyword and uses this metric to determine whether to suggest additional contribution in the keyword. The potential efficient contribution generally describes (i) an absolute contribution value that a content provider could contribute toward a keyword in a campaign while maintaining or improving a threshold efficiency associated with the campaign, or (ii) an amount of contribution that a content provider could increase from a current level of contributions for a keyword in a campaign while maintaining or improving the threshold efficiency (i.e., a difference between the absolute potential contribution value and the content provider's current contribution). For example, the threshold efficiency may be equal to the average efficiency that a campaign currently realizes across multiple keywords in the campaign. In some implementations, process 300 can choose to suggest a keyword if the increased investment in a keyword would result in an estimated efficiency that at least satisfies the threshold efficiency. If the threshold efficiency is satisfied, then at stage 316 the process 300 can provide the keyword as a suggestion to the content provider as potentially warranting increased investment.

In some cases, a content distribution service may allow content providers to specify other parameters for a campaign in addition to, or alternatively to, keyword offers. For example, the content provider may select one or more demographic profiles of end users to target with a campaign, and/or may select categories of mobile applications, web sites, or other electronic resources to target with the campaign where the content (e.g., sponsored content) is desired to be placed. A content provider may constantly be seeking to refine such campaign parameters to most effectively deliver their content to end users. Sometimes, adjustments to these parameters can impact the efficiency of a campaign. For example, a campaign that currently invests $1,000 per month in targeting content to a particular demographic group could potentially increase its contribution efficiently toward group to $5,000 per month. In some implementations, similar techniques that are used to determine the potential efficient contribution and suggestions for keywords can be applied to determine the potential efficient contribution and suggestions for other campaign parameters.

Along these lines, FIG. 4 depicts a flowchart of an example process 400 for determining the potential efficient contribution of a given campaign parameter and taking action (e.g., making suggestions or automatic campaign adjustments) based on the potential efficient contribution for the parameter. At stage 402, the process 400 identifies the parameter to evaluate. At stage 404, the process 400 predicts contribution costs for targeting the campaign parameter over a coming period of time. At stage 406, estimated levels of user interaction with content that are predicted to result from the campaign at the predicted contribution costs directed to the identified parameter are identified. Based on the predicted (estimated) contribution costs and estimated levels of user interaction, the process 400 can then determine estimated efficiencies associated with the campaign parameter. At stage 410, the process 400 determines whether to suggest or make automatic adjustments to the identified campaign parameter based on the estimated efficiencies. In some implementations, the determination can involve determining the potential efficient contribution for the campaign parameter. At stage 412, adjustments to the campaign parameter can be suggested to the content provider or automatically implemented based on the estimated efficiencies of the campaign parameter at one or more different levels of contribution.

FIG. 5 depicts a screenshot of an example user interface 500 that provides an interactive environment for presenting keyword suggestions to users and for making automatic changes to a campaign to increase efficient contribution for one or more keywords. The user interface 500 is shown as part of a web application presented by a web browser, but in some implementations the user interface 500 may be provided in native applications, mobile applications, or in other forms. In some implementations, the user interface 500 may be generated by the campaign interface 220. The campaign interface 220 may automatically or upon request transmit code to a content provider's device (e.g., HTML and other web code) that, when executed, causes the user interface 500 to be presented by the content provider's device.

In the example of FIG. 5, campaign information is shown for the fictional content provider “Ted's Bike & Ski Shop,” a retailer of outdoor gear specializing in cycling and winter sports. The user interface 500 first includes a list of keywords 502 for which the content provider is currently invested in the campaign. The list of keywords 502 may be a current list of keywords that have outstanding offers in the campaign and may also include keywords that the content provider has previously made offers for in the campaign or another campaign, even if those keywords do not currently have outstanding offers. For example, the list of keywords in which “Ted's Bike & Ski Shop” has placed offers includes “bike,” “cycling,” “helmet, “snowboard,” and others.

The user interface 500 further includes a first input field 504, a second input field 506, and an efficiency analysis control 508 that a user can interact with in order to invoke an efficiency analysis on one or more keywords in the campaign. The first input field 504 is configured to receive input indicating a target future timeframe for which the content provider desires the efficiency analysis to be performed. For example, the content provider may wish to receive efficiency-based keyword suggestions for keywords over the next day, week, month, or more and can indicate a preference for the timeframe in input field 504. The second input field 506 (shown as a drop-down selection menu) is configured to receive user input that indicates the efficiency threshold that the content provider desires to be used for the analysis. The input field 506 may provide one or more pre-defined types of thresholds, such as the average campaign efficiency (e.g., average efficiency of all keywords in the list 502), an efficiency associated with a particular keyword in the list 502, an average efficiency of two or more keywords selected from the list 502, an average efficiency associated with one or more other campaigns determined to be similar to “Ted's Bike & Ski Shop” campaign, and others. In some implementations, the second input field 506 may allow a user to manually specify a threshold efficiency value. Once the user has input the parameters for the analysis, the efficiency analysis control 508 can be selected to cause the analysis to be performed. For example, a request that includes the user-defined parameters from input fields 504 and 506 may be sent to a keyword evaluator on content distribution servers, and a result of the analysis performed on the servers may be returned to the client device that presents the user interface 500. In some implementations, selecting the control 508 causes an efficiency analysis to be run on all the keywords in the list 502. In some implementations, a user may select a subset of one or more of the keywords from the list 502 to be analyzed. The user may also opt-in or opt-out of receiving suggestions for additional keywords that are not included in the list of currently invested keywords 502.

In some implementations, the efficiency analysis is performed immediately upon the user's selection of control 508 so as to provide the user with near-instantaneous results. The user interface 500 can be updated to present, within a display of a user device, a visualization of a list of suggested keywords 510 based on the analysis. The keywords in the list 510 can include, in some implementations, keywords from the list of currently invested keywords 502 and/or newly identified keywords that the efficiency analysis indicates the content provider could efficiently increase contributions in over the target future period of time. For example, the keywords “bike parts” and “mountain bike” may have efficiencies below the campaign's average efficiency currently, but the system predicts that the content provider could increase contributions for those keywords while maintaining or improving the campaign's average efficiency (threshold efficiency). Other keywords, such as “dirt bike” and “boots” are suggested to the content provider even though the content provider has not previously placed an offer on those keywords in the campaign. In some implementations, the user can select one of the keywords from the list 510 to view additional details about the analysis of that keyword. For instance, user interaction with one of the keywords can invoke a script that updates the user interface 500 to present a visualization of the additional details. For example, FIG. 5 shows that the user has selected “mountain bike,” thereby causing (e.g., using scripted code) the data populated on the right side of the user interface 500 to be updated with information corresponding to the selected keyword (mountain bike). The selection is indicated by the keyword identification field 514.

Beneath the keyword identification field 514, the user interface 500 includes a current campaign data field 516, a suggested keyword data field 518, and a modify contribution control 520. The current campaign data field 516 generally shows data concerning a present or historical state of the campaign, the selected keyword (e.g., “mountain bike”), or both. The example data shown in FIG. 5 indicates that the content provider has imposed a $5,000 budget cap on the campaign as a whole, and an $800 budget cap on contributions associated with the “mountain bike” keyword. The average keyword efficiency in the campaign is 0.12 clicks/dollar (although other efficiency metrics may be specified additionally or alternatively, such as impressions/dollar or conversions/dollar). The content provider's current maximum CPM offer for “mountain bike” is $4.00, and with these constraints currently achieves an efficiency of 0.05 clicks/dollar with the “mountain bike” keyword. The total actual contribution associated with “mountain bike” over a period of time was $800, indicating that the content provider has reached the top of the specified keyword budget.

The suggested keyword data field 518 shows results of the efficiency analysis for a given keyword. For example, the data field 518 can include a total potential efficient contribution value that identifies how much the content provider could efficiently contribute in total over the targeted period of time, a total potential efficient contribution increase value that identifies by how much the content provider could efficiently increase the actual keyword contribution, and the estimated efficiency that is predicted to occur if the content provider increased contribution according to the suggestion. The data field 518 can also show parameters for updating a campaign to achieve the potential efficient contribution. For example, if “Ted's Bike & Ski Shop” were to increase its offer on “mountain bike” from $4.00 to $6.25, and were to increase its keyword budget from $800 to $1,800 as shown in the user interface 500, then the system estimates that the content provider would raise the keyword's efficiency from 0.05 clicks/dollar to 0.12 clicks/dollar.

In some implementations, the user interface 500 can include a presentation of a modify contribution control 520. The modify contribution control 520, when selected, can automatically cause multiple different adjustments to the campaign parameters that are necessary to realize the potential efficient contribution and achieve the estimated efficiency. For example, upon the selecting the modify contribution control 520 in “Ted's Bike & Ski Shop” campaign, the campaign manager can automatically adjust the offer for the “mountain bike” keyword to $6.25 and increase the budget to $1,800 for at least the targeted period of time. In some implementations, the operations associated with both the efficiency analysis control 508 and the modify contribution control 520 can be combined to create an even more automated user experience. In this manner, when the user selected such a combined control, the efficiency analysis can automatically be performed on one or more keywords and campaign parameters can be automatically adjusted for particular ones of the analyzed keywords where additional contribution would maintain or improve the efficiency of the campaign or keyword, for example. In some implementations, a single control may be provided that is configured to cause the campaign manager, in response to a user selection of the control, to automatically modify the campaign to implement multiple changes to multiple keywords, such as all the keywords that have been identified as opportunities for increased efficient contribution. As such, the user interface 500 can facilitate efficient modifications to the campaign (e.g., by not requiring the user to make each of the multiple changes individually).

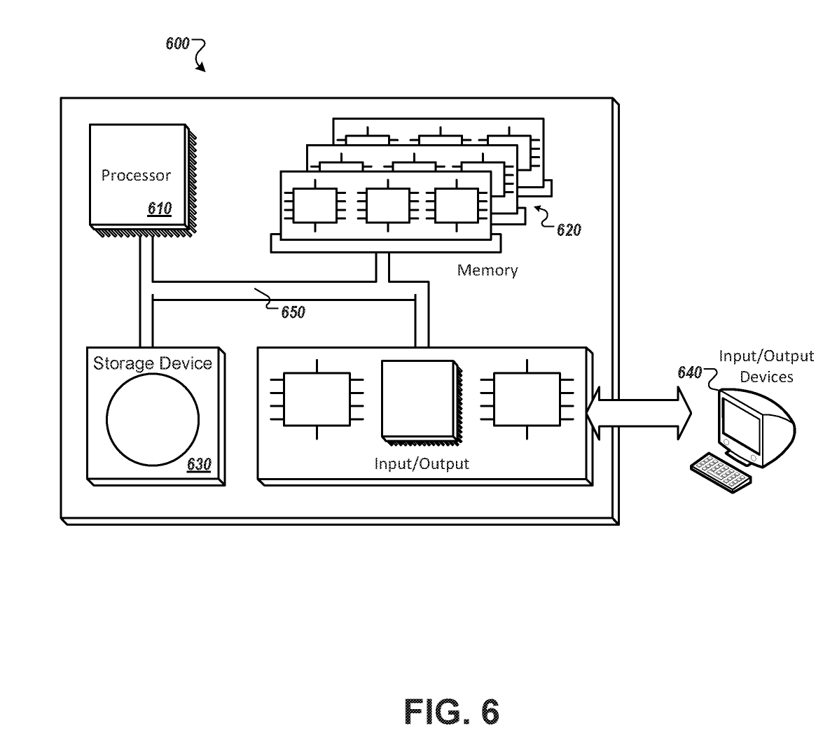

FIG. 6 is a schematic diagram of a computer system 600. In some implementations, the system 600 can be used to carry out the operations described in association with the computer-implemented methods described previously. In some implementations, the computer hardware described in the system 600 may be employed to implement the systems and devices described herein, or components thereof. The system 600 is intended to include various forms of digital computers, such as laptops, desktops, workstations, personal digital assistants, servers, blade servers, mainframes, and other appropriate computers. The system 600 can also include mobile devices, such as personal digital assistants, cellular telephones, smartphones, and other similar computing devices. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. The processor may be designed using any of a number of architectures. For example, the processor 610 may be a CISC (Complex Instruction Set Computers) processor, a RISC (Reduced Instruction Set Computer) processor, or a MISC (Minimal Instruction Set Computer) processor.

In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 400. In one implementation, the storage device 630 is a computer-readable medium. In various different implementations, the storage device 630 may be a floppy disk device, a hard disk device, an optical disk device, or a tape device.

The input/output device 640 provides input/output operations for the system 400. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computing system, comprising:
one or more computers including one or more processors;
a content server, on the one or more computers, that serves content to a client device, wherein the content is (i) selected based at least in part on a keyword associated with a query from the client device and (ii) associated with a particular content provider that has placed an offer in a ranking procedure to contribute to a distribution service to have the content provided along with search results that are generated in response to queries that are associated with the keyword;
a contributions prediction model on the one or more computers that indicates, based on historical offer data, estimated contribution offers for the keyword that are predicted to occur in ranking procedures during a future period of time;
a content performance model on the one or more computers that indicates, based on historical content performance data, estimated levels of user interaction with the content that are predicted to occur during the future period of time;
an efficiency evaluator on the one or more computers that (i) determines an estimated efficiency of the keyword based on at least one of the estimated contribution offers and at least one of the estimated levels of user interaction and (ii) evaluates the estimated efficiency of the keyword with respect to a threshold efficiency; and
an interface on the one or more computers that provides, in response to an indication that the estimated efficiency of the keyword is determined to satisfy the threshold efficiency, the keyword as a suggested keyword for which the particular content provider could efficiently increase a contribution level during the future period of time.

2. The computing system of claim 1, wherein:
the historical offer data describes contribution offers placed by a plurality of content providers in previous ranking procedures to have content that is respectively associated with the plurality of content providers provided along with search results generated in response to queries that are associated with the keyword, and
the estimated contribution offers indicated by the contributions prediction model are determined based at least on a portion of the offers placed by the plurality of content providers in the previous ranking procedures.

3. The computing system of claim 1, wherein the efficiency evaluator is operable to determine the threshold efficiency based on actual efficiencies of one or more keywords in a content distribution campaign associated with the particular content provider.

4. The computing system of claim 3, wherein the one or more keywords include multiple keywords, wherein the threshold efficiency comprises an average of the actual efficiencies of the multiple keywords in the content distribution campaign associated with the particular content provider.

5. The computing system of claim 1, wherein:
the content associated with the particular content provider is a first piece of content among multiple pieces of content associated with the particular content provider, and
the content server is enabled to serve different ones of the multiple pieces of content associated with the particular content provider based on the particular content provider having placed a contribution offer to have content provided along with search results generated in response to queries that are associated with the keyword.

6. The computing system of claim 1, wherein the keyword is included in the query.

7. The computing system of claim 1, wherein:
the particular content provider has achieved a first efficiency for the keyword in an actual campaign by placing a contribution offer of a first value for the keyword; and
the estimated efficiency for the keyword indicates how efficient the keyword is predicted to be during the future period of time if the particular content provider were to place a contribution offer of a second value for the keyword for the future period of time, the second value being greater than the first value, the estimated efficiency being equal to or greater than the first efficiency for the keyword that the particular content provider has achieved in the actual campaign.

8. The computing system of claim 7, wherein the interface is operable to provide an indication of the second value or a difference between the second value and the first value to present an indication of how much the particular content provider can increase a contribution offer placed on the keyword without reducing at least one of the first efficiency for the keyword or an average efficiency for multiple keywords in the actual campaign.

9. The computing system of claim 1, wherein the particular content provider is an advertiser and the content served by the content server comprises an advertisement.

10. The computing system of claim 1, wherein:
the historical content performance data describes at least one of historical content click-through rates, click-through volumes, or impressions, and
the estimated levels of user interaction with the content that are predicted to occur during the future period of time comprises estimated content click-through rates, click-through volumes, or impressions.

11. The computing system of claim 1, wherein the estimated efficiency of the keyword is expressed as a ratio of conversions, clicks, or impressions to a level of contribution that is estimated to occur during the period of time.

12. A computer-implemented method, comprising:
identifying, by a computing system, a keyword to evaluate with respect to a particular content provider;
evaluating, by the computing system, historical records of contribution offers for the keyword by a plurality of content providers in order to determine one or more estimated contribution offers for the keyword that would be required to cause the computing system to select content associated with the particular content provider for presentation in an electronic resource related to the keyword;
evaluating, by the computing system, historical records of user interaction with content to determine, for each of the one or more estimated contribution offers, an estimated level of user interaction that would occur with the content associated with the particular content provider if the particular content provider placed the respective estimated offer;
determining, for each of the one or more estimated contribution offers and based at least on the estimated levels of user interaction, an efficiency score that indicates an estimated efficiency of the keyword at a contribution level that corresponds to the respective estimated contribution offer;
determining whether at least one of the efficiency scores satisfies a threshold efficiency score; and
in response to determining that at least one of the efficiency scores satisfies the threshold efficiency score, providing the keyword as a suggestion to the particular content provider.

13. The computer-implemented method of claim 12, further comprising determining the threshold efficiency score based on one or more scores that respectively indicate actual efficiencies of one or more keywords in a campaign associated with the particular content provider.

14. The computer-implemented method of claim 13, wherein determining the threshold efficiency score comprises determining an average of multiple scores that respectively indicate actual efficiencies of multiple keywords in the campaign.

15. The computer-implemented method of claim 12, wherein the computing system is configured, in response to determining that the at least one of the efficiency scores does not satisfy the threshold efficiency score, to not provide the keyword as a suggestion to the particular content provider.

16. The computer-implemented method of claim 12, wherein identifying the keyword comprises selecting a keyword for which the particular content provider has not placed a contribution offer on in a campaign.

17. The computer-implemented method of claim 12, wherein the particular content provider is an advertiser and the content associated with the particular content provider comprises one or more advertisements.

18. The computer-implemented method of claim 12, wherein determining efficiency scores for each of the one or more estimated offers comprises:
generating, based on the estimated contribution offers and the estimated levels of user interaction, a model that indicates estimated efficiencies of the keyword as a function of the particular content provider's contribution level for the keyword; and
evaluating the model.

19. The computer-implemented method of claim 12, wherein:
the estimated levels of user interaction comprise estimated levels of impressions, clicks, or conversions of the content associated with the particular content provider, and
the efficiency scores comprise ratios of the estimated levels of impressions, clicks, or conversions to (i) the estimated contribution offers or (ii) estimated contribution levels that correspond to the estimated offers.

20. A computing system, comprising:
one or more processors; and
one or more computer-readable media having instructions stored thereon that, when executed by the one or more processors, cause performance of operations comprising:
identifying a keyword to evaluate with respect to a particular content provider;
evaluating historical records of contribution offers for the keyword by a plurality of content providers in order to determine one or more estimated contribution offers for the keyword that would be required to cause the computing system to select content associated with the particular content provider for presentation in an electronic resource related to the keyword;
evaluating historical records of user interaction with content to determine, for each of the one or more estimated contribution offers, an estimated level of user interaction that would occur with the content associated with the particular content provider if the particular content provider placed the respective estimated offer;
determining, for each of the one or more estimated contribution offers and based at least on the estimated levels of user interaction, an efficiency score that indicates an estimated efficiency of the keyword at a contribution level that corresponds to the respective estimated contribution offer;
determining whether at least one of the efficiency scores satisfies a threshold efficiency score; and
in response to determining that at least one of the efficiency scores satisfies the threshold efficiency score, providing the keyword as a suggestion to the particular content provider.
